(19) United States
(12) Patent Application Publication
(10) Pub. No.: US 2002/0144054 A1
(43) Pub. Date: Oct. 3, 2002

(54) Prefetch canceling based on most recent accesses

(76) Inventors: Blaise B. Fanning, El Dorado Hills, CA (US); Thomas A. Piazza, Granite Bay, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/823,126

(22) Filed: Mar. 30, 2001

(51) Int. Cl. G06F 13/00

(52) U.S. Cl. 711/108; 711/137

(57) ABSTRACT

The present invention is a method and apparatus to monitor prefetch requests. A storage circuit is coupled to a prefetcher to store a plurality of prefetch addresses which corresponds to most recent prefetch requests from a processor. The prefetcher generates an access request to a memory when requested by the processor. A canceler cancels the access request when the access request corresponds to at least P of the stored prefetch addresses. P is a non-zero integer.

### BACKGROUND

1. Field of the Invention

This invention relates to microprocessors. In particular, the invention relates to memory controllers.

2. Background of the Invention

Prefetching is a mechanism to reduce latency seen by a processor during read operations to main memory. A memory prefetch essentially attempts to predict the address of a subsequent transaction requested by the processor. A processor may have hardware and software prefetch mechanisms. A chipset memory controller uses only hardware-based prefetch mechanisms. A hardware prefetch mechanism may prefetch instructions only, or instruction and data. Typically, a prefetch address is generated by hardware and the instruction/data corresponding to the prefetch address is transferred to a cache unit or a buffer unit in chunks of several bytes, e.g., 32-byte.

When receiving a data request, a prefetcher may create a speculative prefetch request, based upon its own set of rules. The prefetch request is generated by the processor based on some prediction rules such as branch prediction. Since memory prefetching does not take into account the system caching policy, prefetching may result in poor performance when the prefetch information turns out to be unnecessary or of little value.

### BRIEF DESCRIPTION OF THE DRAWINGS

The features and advantages of the present invention will become apparent from the following detailed description of the present invention in which:

FIG. 1 is a diagram illustrating a system in which one embodiment of the invention can be practiced.

FIG. 2 is a diagram illustrating a memory controller hub shown in FIG. 1 according to one embodiment of the invention.

FIG. 3 is a diagram illustrating a prefetch monitor circuit shown in FIG. 2 according to one embodiment of the invention.

FIG. 4 is a diagram illustrating a prefetch monitor circuit shown in FIG. 2 according to another embodiment of the invention.

FIG. 5 is a flowchart illustrating a process to monitor prefetch requests according to one embodiment of the invention.

### DETAILED DESCRIPTION OF THE INVENTION

In the following description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention. For examples, although the description of the invention is directed to an external memory control hub, the invention can be practiced for other devices having similar characteristics, including memory controllers internal to a processor. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

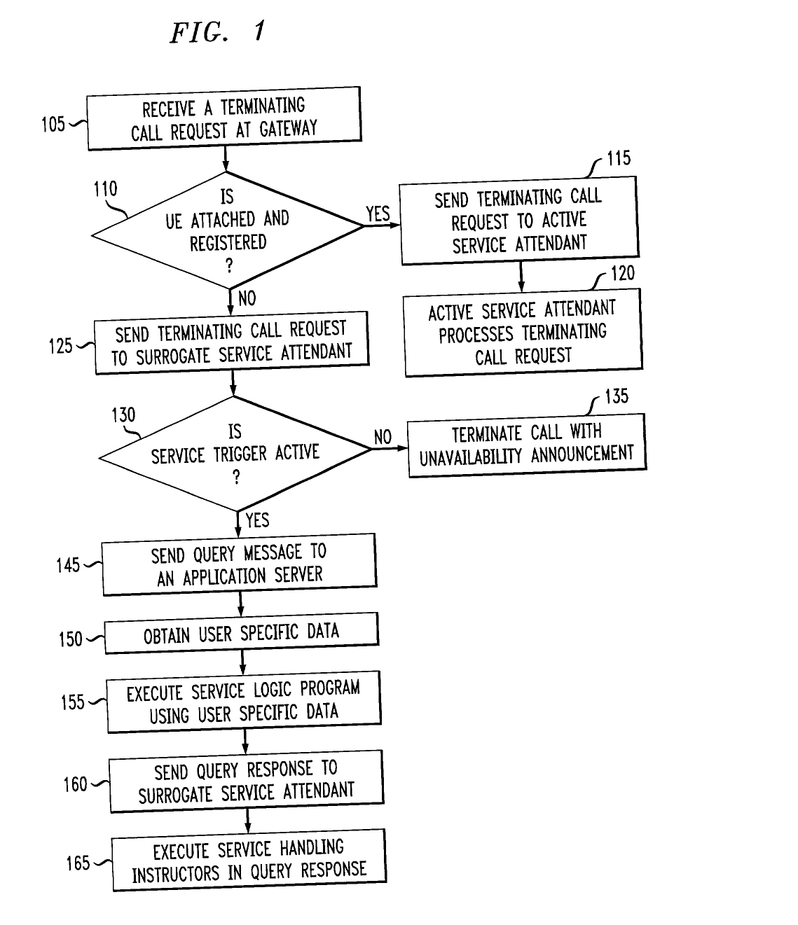

FIG. 1 is a diagram illustrating a computer system 100 in which one embodiment of the invention can be practiced. The computer system 100 includes a processor 110, a host bus 120, a memory control hub (MCH) 130, a system memory 140, an input/output control hub (ICH) 150, a mass storage device 170, and input/output devices 180₁ to 180_{K}.

The processor 110 represents a central processing unit of any type of architecture, such as embedded processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture. In one embodiment, the processor 110 is compatible with the Intel Architecture (IA) processor, such as the IA-32 and the IA-64. The host bus 120 provides interface signals to allow the processor 110 to communicate with other processors or devices, e.g., the MCH 130. The host bus 120 may support an uni-processor or multiprocessor configuration. The host bus 120 may be parallel, sequential, pipelined, asynchronous, synchronous, or any combination thereof.

The MCH 130 provides control and configuration of memory and input/output devices such as the system memory 140 and the ICH 150. The MCH 130 may be integrated into a chipset that integrates multiple functionalities such as the isolated execution mode, host-to-peripheral bus interface, memory control. For clarity, not all the peripheral buses are shown. It is contemplated that the system 100 may also include peripheral buses such as Peripheral Component Interconnect (PCI), accelerated graphics port (AGP), Industry Standard Architecture (ISA) bus, and Universal Serial Bus (USB), etc. The MCH 130 includes a prefetch circuit 135 to prefetch information from the system memory 140 based upon request patterns generated by the processor 110. The prefetch circuit 135 will be described later.

The system memory 140 stores system code and data. The system memory 140 is typically implemented with dynamic random access memory (DRAM) or static random access memory (SRAM). The system memory 140 may include program code or code segments implementing one embodiment of the invention. The system memory 140 may also include other programs or data, which are not shown depending on the various embodiments of the invention. The instruction code stored in the memory 140, when executed by the processor 110, causes the processor to perform the tasks or operations as described in the following.

The ICH 150 has a number of functionalities that are designed to support I/O functions. The ICH 150 may also be integrated into a chipset together or separate from the MCH 130 to perform I/O functions. The ICH 150 may include a number of interface and I/O functions such as PCI bus interface, processor interface, interrupt controller, direct memory access (DMA) controller, power management logic, timer, universal serial bus (USB) interface, mass storage interface, low pin count (LPC) interface, etc.

The mass storage device 170 stores archive information such as code, programs, files, data, applications, and operating systems. The mass storage device 170 may include compact disk (CD) ROM 172, floppy diskettes 174, and hard drive 176 and any other magnetic or optic storage devices. The mass storage device 170 provides a mechanism to read machine-readable media.

The I/O devices 180₁ to 180_{K} may include any I/O devices to perform I/O functions. Examples of I/O devices 180₁ to 180_{K} include controller for input devices (e.g., keyboard, mouse, trackball, pointing device), media card (e.g., audio, video, graphics), network card, and any other peripheral controllers.

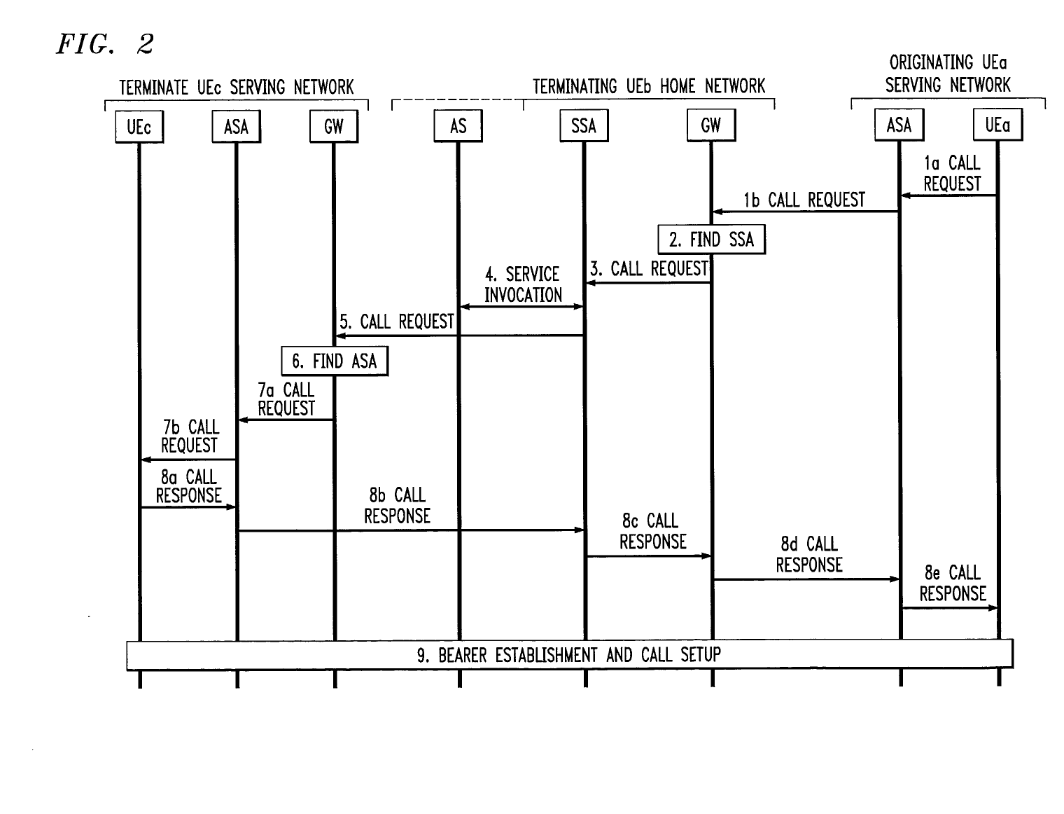

FIG. 2 is a diagram illustrating a prefetch circuit 135 shown in FIG. 1 according to one embodiment of the invention. The prefetch circuit 135 includes a prefetcher 210 and a prefetch monitor circuit 220.

The prefetcher 210 receives data and instruction requests from the processor 110. The information to be prefetched may include program code or data, or both. The processor 110 itself may have a hardware prefetch mechanism or a software prefetch instruction. The hardware prefetch mechanism automatically prefetches instruction code or data. Data may be read in chunks of bytes starting from the target address. For instruction and data, the hardware mechanism brings the information into a unified cache (e.g., second level cache) based on some rules such as prior reference patterns. The prefetcher 210 receives the prefetch information including the requests for required data and prefetch addresses generated by the processor 110. From this information, the memory controller 130 first generates memory requests to satisfy the processor data or instruction requests. Subsequently, the prefetcher 210 generates an access request to the memory via the prefetch monitor circuit 220. The prefetcher 210 passes to the prefetch monitor circuit 220 the currently requested prefetch address to be sent to the memory 140. The prefetcher 210 can abort the prefetch if it receives a prefetch cancellation request from the prefetch monitor circuit 220.

The prefetch monitor circuit 220 receives the prefetch addresses generated by the prefetcher 210. In addition, the prefetch monitor circuit 220 may receive other information from the prefetcher 210 such as a prefetch request type (e.g., read access, instruction prefetch, data prefetch) and a current prefetch address. The prefetch monitor circuit 220 monitors the prefetch demand and decides whether or not the current prefetch request should be accepted or canceled (e.g., declined). If the prefetch monitor circuit 220 accepts the prefetch request, it allows the prefetch access and the prefetch information such as the current prefetch address to pass through to the memory 140 to carry out the prefetch operation. If the prefetch monitor circuit 220 rejects, cancels, or declines the prefetch request because it decides that the prefetch is not useful, it will assert a cancellation request to the prefetcher 210 so that the prefetcher 210 can abort the currently requested prefetch operation. By aborting non-useful prefetch accesses, the prefetcher 210 increases memory access bandwidth while still maintaining a normal prefetch mechanism for increased system performance.

FIG. 3 is a diagram illustrating the prefetch monitor circuit 220 shown in FIG. 2 according to one embodiment of the invention. The prefetch monitor circuit 220 includes a storage circuit 310 and a prefetch canceler 320.

The storage circuit 310 stores the most recent request addresses generated by the processor 110 (FIG. 1), or from the prefetcher 210 (FIG. 2). The storage circuit 310 retains a number of the most recent addresses, i.e., addresses of the last, or most recent, L pieces of data. The number L may be fixed and predetermined according to some rule and/or other constraints. Alternatively, the number L may be variable and dynamically adjusted according to some dynamic condition and/or the overall access policy. The storage circuit 310 is a queue that stores first-in-first-out (FIFO) prefetch addresses. Alternatively, the storage circuit 310 may be implemented as a content addressable memory (CAM) as illustrated in FIG. 4. A FIFO of size L essentially stores the most recent L prefetch or request addresses. One way to implement such a FIFO is to use a series of registers connected in cascade.

In the embodiment shown in FIG. 3, the storage circuit 310 includes L registers 315₁ to 315_{L} connected in series or cascaded. The L registers 315₁ to 315_{L} essentially operates like a shift register having a width equal to the size of the prefetch address. Suppose the size of the fetch and prefetch addresses are M-bit. Then the L registers 315₁ to 315_{L} may be alternatively implemented as M shift registers operating in parallel. In either case, the registers are clocked by a common clock signal generated from a write circuit 317. This clock signal may be derived from the prefetch request signal generated by the processor 110 such that every time the processor 110 generates a prefetch request, the L registers 315₁ to 315_{L} are shifted to move the prefetch addresses stored in the registers one position forward. The write circuit 317 may include logic gates to decode the cancellation request and the prefetch and data requests from the processor 110. The write circuit 317 may also include flip-flops to synchronize the timing. The storing and shifting of the L registers 315₁ to 315_{L} may be performed after the prefetch canceler 320 completes its operation. If the prefetch canceler 320 provides no cancellation request, indicating that the current prefetch address does not match to at least P of the stored prefetch addresses in the L registers 315₁ to 315_{L}, then the current prefetch address is written into the first register after the L registers 315₁ to 315_{L} are shifted. Otherwise, writing and shifting of the L registers 315₁ to 315_{L} is not performed. The output of each register is available outside the storage circuit 310. These outputs are fed to the prefetch canceler 320 for matching purpose.

The prefetch canceler 320 matches the currently requested prefetch, data or instruction, request address with the stored prefetch, data, or instruction request addresses from the storage circuit 310. The basic premise is that it is unlikely that an instruction code or a piece of data read from the memory will be read again. In other words, the current prefetch request may be useless or unnecessary because the prefetch information may turn out to be unnecessary and prefetching would waste memory bandwidth. This mechanism helps the MCH 130 deal with pathological address patterns that can otherwise cause it to prefetch unnecessarily. The prefetch canceler 320 includes a matching circuit 330, a cancellation generator 340, and an optional gating circuit 350.

The matching circuit 330 matches a current prefetch address associated with the access request with the stored prefetch, data or instruction, request addresses from the storage circuit 310. The matching circuit 330 includes L comparators 335₁ to 335_{L} corresponding to the L registers 315₁ to 315_{L}. Each of the L comparators 335₁ to 335_{L} compares the current prefetch address with each output of the L registers 315₁ to 315_{L}. The L comparators 335₁ to 335_{L} are designed to be fast comparators and operate in parallel. If the comparators are fast enough, less than L comparators may be used and each comparator may perform several comparisons. The prefetch addresses can be limited to within a block of cache lines having identical upper address bits. Therefore, the comparison may be performed on the lower bits of the address to reduce hardware complexity and to increase comparison speed. Each of the L comparators 335₁ to 335_{L} generates a comparison result. For example, the comparison result may be a logical HIGH if the current prefetch address is equal or matched with the corresponding stored prefetch address, and a logical LOW if the two do not match.

The cancellation generator 340 generates a cancellation request to the prefetcher 210 (FIG. 2) when the current prefetch address matches to at least one of the stored prefetch, data or instruction, request addresses. Depending on the policy used, the cancellation generator 340 may generate the cancellation request when the current prefetch address matches to at least or exactly P stored addresses, where P is a non-zero integer. The number P may be determined in advance or programmable. The cancellation generator 340 includes a comparator combiner 345 to combine the comparison results from the comparators. The combined comparison result corresponds to the cancellation request. The comparator combiner 345 may be a logic circuit to assert the cancellation request when the number of asserted comparison results is at least P. When P=1, the comparator combiner 345 may be an L-input OR gate. In other words, when one of the comparison results is logic HIGH, the cancellation request is asserted. When P is greater than one, the comparator combiner 345 may be a decoder that decodes the comparison results into the cancellation request.

The gating circuit 350 gates the access request to the memory 140. If the cancellation request is asserted, indicating that the access request for the prefetch operation is canceled, the gating circuit 350 disables the access request. Otherwise, if the cancellation request is negated, indicating that the access request is accepted, the gating circuit 350 allows the access to proceed to the memory 140.

FIG. 4 is a diagram illustrating the prefetch monitor circuit 220 shown in FIG. 2 according to another embodiment of the invention. The prefetch monitor circuit includes a storage circuit 410 and a prefetch canceler 420.

The storage circuit 410 performs the same function as the storage circuit 310 (FIG. 3). The storage circuit 410 is a content addressable memory (CAM) 412 having L entries 415₁ to 415_{L}. These entries corresponding to the L most recent prefetch, data or instruction, request addresses.

The prefetch canceler 420 essentially performs the same function as the prefetch canceler 320 (FIG. 3). The prefetch canceler 420 includes a matching circuit 430, a cancellation generator 440, and an optional gating circuit 450. The matching circuit 430 matches the current prefetch address with the L entries 415₁ to 415_{L}. The matching circuit 430 includes an argument register 435. The argument register 435 receives the current prefetch address and presents it to the CAM 412. The CAM 412 has internal logic to locate the entries that match to the current prefetch register. The CAM 412 searches the entries and locates the matches and returns the result to the cancellation generator 440. Since the CAM 412 performs the search in parallel, the matching is fast. The cancellation generator 440 receives the result of the CAM search. The cancellation generator 440 asserts a match indicator corresponding to the cancellation request if the search result indicates that the current prefetch address is matched to at least P entries in the CAM 412. Otherwise, the cancellation generator 440 negates the match indicator and the current prefetch address is written into the CAM 412. The gating circuit 450 gates the current prefetch address and request to the memory 140 in a similar manner as the gating circuit 350 (FIG. 3).

FIG. 5 is a flowchart illustrating a process 500 to monitor prefetch requests according to one embodiment of the invention.

Upon START, the process 500 receives an access request and a current prefetch address associated with the access request (Block 510). The access request comes from the processor, while the prefetch request is generated from within the memory controller, based on an internal hardware mechanism. Then, the process 500 generates an access request to the memory via the prefetch monitor circuit in response to the processor's access request (Block 520), as well as a prefetch request to memory via the same prefetch monitor circuit. Next, the process 500 stores the access requests in a storage circuit and attempts to match the current prefetch address with the stored prefetch, data and instruction, addresses in the storage circuit of the prefetch monitor circuit (Block 530).

Then, the process 500 determines if the current prefetch address matches with at least P of the stored prefetch, data or instruction, addresses (Block 540). If so, the process 500 generates a cancellation request to the prefetcher (Block 550). Then, the process 500 aborts the prefetch operation (Block 560) and is then terminated. If the current prefetch address does not match with at least P of the stored prefetch, data or instruction, addresses, the process 500 stores the current prefetch address corresponding to the processor's prefetch request in the storage element of the prefetch monitor circuit (Block 570). The storage element stores L most recent prefetch addresses. Next, the process 500 proceeds with the prefetch operation and prefetches the requested information from the memory (Block 580) and is then terminated.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. An apparatus comprising:
a storage circuit coupled to a prefetcher to store a plurality of prefetch addresses, the plurality of prefetch addresses corresponding to most recent access requests from a processor, the prefetcher generating an access request to a memory when requested by the processor; and
a canceler coupled to the storage circuit and the prefetcher to cancel the access request when the access request corresponds to at least P of the stored prefetch addresses, P being a non-zero integer.

2. The apparatus of claim 1 wherein the storage circuit comprises:
a storage element to store the plurality of prefetch addresses from the most recent access requests by the processor, the storage element being one of a queue with a predetermined size and a content addressable memory (CAM).

3. The apparatus of claim 2 wherein the queue comprises:
a plurality of registers cascaded to shift the prefetch addresses each time the processor generates an access request.

4. The apparatus of claim 3 wherein the canceler comprises:
a matching circuit to match a current prefetch address associated with the access request with the stored prefetch addresses.

5. The apparatus of claim 4 wherein the canceler further comprises:
a cancel generator coupled to the matching circuit to generate a cancellation request to the prefetcher when the current prefetch address matches to the at least P of the stored prefetch addresses.

6. The apparatus of claim 4 wherein the matching circuit comprises:
a plurality of comparators to compare the current prefetch address with each of the stored prefetch addresses.

7. The apparatus of claim 4 wherein the matching circuit comprises:
a plurality of comparators to compare the current prefetch address with contents of the plurality of registers, the comparators generating comparison results.

8. The apparatus of claim 7 wherein the cancel generator comprises:
a comparator combiner coupled to the comparators to combine the comparison results, the combined comparison results corresponding to the cancellation request.

9. The apparatus of claim 2 wherein the canceler comprises:
a matching circuit having an argument register to store the current prefetch address for matching with entries of the CAM.

10. The apparatus of claim 9 wherein the canceler further comprises:
a cancellation generator to generate a match indicator when the current prefetch address matches at least P of the entries, the match indicator corresponding to the cancellation request.

11. A method comprising:
storing a plurality of prefetch addresses in a storage circuit, the plurality of prefetch addresses corresponding to most recent access requests from a processor, the prefetcher generating an access request to a memory when requested by the processor; and
canceling the access request when the access request corresponds to at least P of the stored prefetch addresses, P being a non-zero integer.

12. The method of claim 11 wherein storing comprises:
storing the plurality of prefetch addresses in one of a queue with a predetermined size and a content addressable memory (CAM).

13. The method of claim 12 wherein storing the plurality of prefetch addresses in the queue comprises:
storing the plurality of prefetch addresses in a plurality of registers cascaded to shift the prefetch addresses each time the processor generates a prefetch request.

14. The method of claim 13 wherein canceling comprises:
matching a current prefetch address associated with the access request with the stored prefetch addresses.

15. The method of claim 14 wherein canceling further comprises:
generating a cancellation request to the prefetcher when the current prefetch address matches to the at least P of the stored prefetch addresses.

16. The method of claim 14 wherein matching comprises:
comparing the current prefetch address with each of the stored prefetch addresses.

17. The method of claim 14 wherein matching comprises:
comparing the current prefetch address with contents of the plurality of registers, the comparators generating comparison results.

18. The method of claim 17 wherein generating the cancellation request comprises:
combining the comparison results, the combined comparison results corresponding to the cancellation request.

19. The method of claim 12 wherein canceling comprises:
storing the current prefetch address in an argument register for matching with entries of the CAM.

20. The method of claim 9 wherein canceling further comprises:
generating a match indicator when the current prefetch address matches at least P of the entries, the match indicator corresponding to the cancellation request.

21. A system comprising:
a processor to generate prefetch requests;
a memory to store data; and
a chipset coupled to the processor and the memory, the chipset comprising:
a prefetcher to generate an access request to the memory when requested by the processor;
a prefetch monitor circuit coupled to the prefetcher, the prefetch monitor circuit comprising:
a storage circuit coupled to the prefetcher to store a plurality of prefetch addresses, the plurality of prefetch addresses corresponding to most recent access requests from the processor; and
a canceler coupled to the storage circuit and the prefetcher to cancel the access request when the access request corresponds to at least P of the stored prefetch addresses, P being a non-zero integer.

22. The system of claim 21 wherein the storage circuit comprises:
a storage element to store the plurality of prefetch addresses from the most recent access requests by the processor, the storage element being one of a queue with a predetermined size and a content addressable memory (CAM).

23. The system of claim 22 wherein the queue comprises:
a plurality of registers cascaded to shift the prefetch addresses each time the processor generates an access request.

24. The system of claim 23 wherein the canceler comprises:
a matching circuit to match a current prefetch address associated with the access request with the stored prefetch addresses.

25. The system of claim 24 wherein the canceler further comprises:
a cancel generator coupled to the matching circuit to generate a cancellation request to the prefetcher when the current prefetch address matches to the at least P of the stored prefetch addresses.

26. The system of claim 24 wherein the matching circuit comprises:
a plurality of comparators to compare the current prefetch address with each of the stored prefetch addresses.

27. The system of claim 24 wherein the matching circuit comprises:
a plurality of comparators to compare the current prefetch address with contents of the plurality of registers, the comparators generating comparison results.

28. The system of claim 27 wherein the cancel generator comprises:
a comparator combiner coupled to the comparators to combine the comparison results, the combined comparison results corresponding to the cancellation request.

29. The system of claim 22 wherein the canceler comprises:
a matching circuit having an argument register to store the current prefetch address for matching with entries of the CAM.

30. The system of claim 29 wherein the canceler further comprises:
a cancellation generator to generate a match indicator when the current prefetch address matches at least P of the entries, the match indicator corresponding to the cancellation request.
